(19) United States
(12) Patent Application Publication
(10) Pub. No.: US 2026/0281965 A1
(43) Pub. Date: Sep. 17, 2026

(54) FIRST NETWORK NODE, SECOND NETWORK NODE, A USER EQUIPMENT AND METHODS PERFORMED THEREIN

(71) Applicant: Telefonaktiebolaget LM Ericsson (publ), Stockholm (SE)

(72) Inventors: Fredrik GUNNARSSON, Linköping (SE); Ritesh SHREEVASTAV, Uppslands Väsby (SE); Richárd BÁTORFI, Budapest (HU); Yunjie LU, Shanghai (CN)

(21) Appl. No.: 19/472,953

(22) PCT Filed: Apr. 5, 2024
(86) PCT No.: PCT/SE2024/050326

§ 371 Date: Oct. 6, 2025

(30) Foreign Application Priority Data
Apr. 7, 2023 (WO) PCT/CN2023/086914

(51) Int. Cl. H04W 64/00; H04L 5/00; H04W 24/10

(52) U.S. Cl. CPC H04W 64/003; H04L 5/0055; H04W 24/10

(57) ABSTRACT

Embodiments herein may relate to, for example, a method performed by a first network node for handling location reporting in a wireless communications network. The first network node aligns a reporting configuration with a second network node in which the reporting configuration defines an extension of a baseline periodic location information reporting configuration.

### TECHNICAL FIELD

Embodiments herein relate to a first network node, a second network node, a user equipment (UE), and methods performed therein regarding wireless communication. Furthermore, a computer program product and a computer-readable storage medium are also provided herein. In particular, embodiments herein relate to handling communication, such as handling positioning or determining location of UEs, in a wireless communications network.

### BACKGROUND

In a typical wireless communications network, UEs, also known as wireless communication devices, mobile stations, stations (STA) and/or wireless devices, communicate via a Radio Access Network (RAN) with one or more core networks (CN). The RAN covers a geographical area which is divided into service areas or cells, with each service area or cell being served by a radio network node such as an access node, e.g., a Wi-Fi access point or a radio base station (RBS), which in some networks may also be called, for example, a NodeB, a gNodeB, or an eNodeB. The service area or cell is a geographical area where radio coverage is provided by the radio network node. The radio network node operates on radio frequencies to communicate over an air interface with the UEs within range of the radio network node. The radio network node communicates over a downlink (DL) to the UE and the UE communicates over an uplink (UL) to the radio network node.

A Universal Mobile Telecommunications System (UMTS) is a third generation (3G) telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with user equipment. In a forum known as the Third Generation Partnership Project (3GPP), telecommunications suppliers propose and agree upon standards for present and future generation networks and investigate, e.g., enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3GPP and coming 3GPP releases, such as New Radio (NR), are worked on. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an architecture comprising radio network nodes connected directly to one or more core networks.

With the emerging 5G technologies such as new radio (NR), the use of very many transmit- and receive-antenna elements may be of great interest as it makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

FIG. 1 depicts the 5G reference architecture as defined by 3GPP. The network functions (NF) shown in FIG. 1 are described below.

The Application Function (AF) or Application Server (AS) interacts with the 3GPP Core Network and allows external parties to use the Exposure Application Programming Interfaces (API) offered by the network operator. The AF provides session related information to other nodes in the 5G core network (5GC).

The Network Exposure Function (NEF) supports different functionalities and NEF supports different Exposure APIs.

Network Repository Function (NRF) works as a registration centre of Network Functions (NF).

The Unified Data Repository (UDR) stores data grouped into distinct collections of subscription-related information: Subscription Data; Policy Data; Structured Data for Exposure; Application Data.

The Session Management Function (SMF) supports different functionalities, e.g. SMF receives policy and charging control (PCC) rules from the Policy Control Function (PCF) and configures the User Plane Function (UPF) accordingly.

The UPF supports handling of user plane traffic based on the rules received from the SMF, e.g., packet inspection and different enforcement actions such as Quality of Service (QoS) handling.

The PCF supports a unified policy framework to govern the network behaviour. Specifically, the PCF provides PCC rules to the Policy and Charging Enforcement Function (PCEF), i.e., the SMF and/or UPF that enforces policy and charging decisions according to provisioned PCC rules.

The Access and Mobility Management Function (AMF) manages UE access, e.g., when a UE is connected through different access networks, and UE mobility aspects.

Charging Function (CHF) manages charging of services and/or functions. The CHF includes: Online Charging Function (OCF) specified in TS 32.296 v17.0.0 providing quota management functionality under Credit-Control terminology; and Charging Data Function (CDF) specified in clause 4.3.1.2 32.240 v 18.0.0, providing Charging Data Records (CDR) generation functionality for charging events.

Network Slice Selection Function (NSSF), not shown, selects the network slicing instance (NSI), determines the allowed network slice selection assistance information (NSSAI) and sets AMF to serve the UE.

Positioning in 4G/LTE/EPC and 5G/NR/5GC is supported by the architecture in FIG. 2, with direct interactions between a UE 100 and a location server 130 via the LTE Positioning Protocol (LPP) 171. Moreover, there are also interactions between the location server 130 and the serving radio base station 110 via the network location protocol 172, to some extent supported by interactions between the radio base station 110 and the UE 100 via the Radio Resource Control (RRC) protocol 170. The radio base station 110 interacts with a mobility network entity 120 via a first interface protocol 173, and the mobility network entity 120 interacts with the location server 130 via a second interface protocol 174. The location server also interacts with a location gateway function 140 via a location management protocol 175, either directly as in FIG. 2 or via the mobility network entity 120. In the latter case, the network mobility entity 120 will act as an intermediate node in between the location server 130 and the location gateway 140. The location gateway function 140 exposes location information via a first exposure protocol 176 either directly to an application function 160 or via a network exposure function 150. In the latter case, the second exposure protocol 177 is between the network exposure function 150 and the application function 160.

In 4G/LTE/EPC and 5G/NR/5GC, the servers/nodes/functions/interfaces/protocols are named as follows:

| Generic name | Name in 4G/LTE/EPC | Name in 5G/NR/5GC |
|---|---|---|
| Location server (130) | Evolved Serving Mobile | Location Management |
| | Location Center (E-SMLC) or | Function (LMF) or SLP |
| | SLP | |
| Radio base station (110) | eNodeB | gNodeB |
| Mobility network entity (120) | Mobility Management Entity | Access and Mobility |
| | (MME) | Management Function (AMF) |
| Network location protocol | LTE Positioning Protocol | New Radio Positioning |
| (172) | annex (LPPa) | Protocol annex (NRPPa) |
| First interface (173) | S1-MME | N2 |
| Second interface (174) | SLS | NL1 |
| Second interface (174) | SLS | NL1 |
| location management | | Nlmf |
| protocol (175) | | |
| First exposure protocol (176) | | NL5 (Ngmlc) |
| Second exposure protocol | | Nss (Nnef) |
| (177) | | |

In both cases, the location server 130 can also be interacting with the UE directly over user plane communication carrying LPP 171 with signaling defined by Open Mobile Alliance (OMA) Secure User Plane Location (SUPL) or some other user plane (UP) signaling. In case of SUPL, the location server is denoted SUPL Location Platform (SLP) and the device is denoted SUPL Enabled Terminal (SET).

FIG. 3 illustrates the different 4G/LTE/EPC and 5G/NR/5GC entities in the more complete and common architecture.

5G positioning methods based on 5G signals are realized with downlink positioning reference signals, associated to a specific radio resource, which may be transmitted using a radio beam with directivity. Each positioning reference signal is associated to an identifier. One or more such signals are transmitted from a specific transmission point associated to a radio base station 110.

Positioning methods rely on measurements, and several positioning methods rely on device measurements of Global navigation satellite system (GNSS) signals, WiFi signals, Bluetooth signals, beacon signals, radio access technology (RAT)-dependent signals, etc.

An application function or some other network function may request location information, either as position measurements or position estimates, from a different network function/node or from a device. Such requests can be for on demand (immediate) or periodic location information.

### SUMMARY

As part of developing embodiments herein one or more problems have been identified. Given the architecture described above supporting a nominal periodic location information transfer through the network and over the different interfaces, there are also specific industrial application requirements for finer reporting in time and limitless amount of reporting to the network applications. Such extensions are delicate and have to be introduced in a way to ensure backward compatibility.

An object herein is to provide a mechanism to handle location information in an efficient manner in the wireless communications network.

According to an aspect the object is achieved, according to embodiments herein, by providing a method performed by a first network node, such as an NF node, a NEF, a Gateway mobile location center (GMLC), an LMF, a SLP, a location node or similar, for handling location reporting in a wireless communications network. The first network node aligns a reporting configuration with a second network node, wherein the reporting configuration defines an extension of a baseline periodic location information reporting configuration.

According to another aspect the object is achieved, according to embodiments herein, by providing a method performed by a second network node, such as NF node, an AF, an LMF, a SLP, a UE, a location node or similar, for handling location reporting in a wireless communications network. The second network node aligns a reporting configuration with a first network node, wherein the reporting configuration defines an extension of a baseline periodic location information reporting configuration.

According to still another aspect the object is achieved, according to embodiments herein, by providing a first network node, and a second network node configured to perform the methods herein, respectively.

Thus, according to an aspect the object is achieved, according to embodiments herein, by providing a first network node, such as a NF node, a location node or similar, for handling location reporting in a wireless communications network. The first network node is configured to align a reporting configuration with a second network node, wherein the reporting configuration defines an extension of a baseline periodic location information reporting configuration.

According to another aspect the object is achieved, according to embodiments herein, by providing a second network node, such as NF node, a location node, for handling location reporting in a wireless communications network. The second network node is configured to align a reporting configuration with a first network node, wherein the reporting configuration defines an extension of a baseline periodic location information reporting configuration.

According to another aspect the object is achieved, according to embodiments herein, by providing a method performed by a first network node for handling location reporting in a wireless communications network. The first network node receives a request from a second network node comprising a suggested periodic reporting extension in addition to a baseline periodic reporting configuration; and transmits to the second network node: an acknowledgement of the periodic location information extension configuration; an alternative supported periodic location information extension configuration; or a baseline response where only the baseline periodic reporting configuration in the request is to be supported, and thereby aligning a reporting configuration with the second network node.

According to another aspect the object is achieved, according to embodiments herein, by providing a method performed by a second network node for handling location reporting in a wireless communications network. The second network node transmits a request to a first network node comprising a suggested periodic reporting extension in addition to a baseline periodic reporting configuration; and receives from the first network node: an acknowledgement of the periodic location information extension configuration, an alternative supported periodic location information extension configuration, or a baseline response where only the baseline periodic reporting configuration in the request is to be supported, and thereby aligning a reporting configuration with the first network node.

According to another aspect the object is achieved, according to embodiments herein, by providing a method performed by a UE for handling location reporting in a wireless communications network. The UE transmits a request to a first network node comprising a suggested periodic reporting extension in addition to a baseline periodic reporting configuration; and receives from the first network node: an acknowledgement of the periodic location information extension configuration, an alternative supported periodic location information extension configuration, or a baseline response where only the baseline periodic reporting configuration in the request is to be supported, and thereby aligning a reporting configuration with the first network node.

According to another aspect the object is achieved, according to embodiments herein, by providing a first network node for handling location reporting in a wireless communications network. The first network node is configured to receive a request from a second network node comprising a suggested periodic reporting extension in addition to a baseline periodic reporting configuration; and transmit to the second network node: an acknowledgement of the periodic location information extension configuration; an alternative supported periodic location information extension configuration; or a baseline response where only the baseline periodic reporting configuration in the request is to be supported, and thereby aligning a reporting configuration with the second network node.

According to another aspect the object is achieved, according to embodiments herein, by providing a second network node for handling location reporting in a wireless communications network. The second network node is configured to transmit a request to a first network node comprising a suggested periodic reporting extension in addition to a baseline periodic reporting configuration; and receive from the first network node: an acknowledgement of the periodic location information extension configuration, an alternative supported periodic location information extension configuration, or a baseline response where only the baseline periodic reporting configuration in the request is to be supported, and thereby aligning a reporting configuration with the first network node.

According to another aspect the object is achieved, according to embodiments herein, by providing a UE for handling location reporting in a wireless communications network. The UE is configured to transmit a request to a first network node comprising a suggested periodic reporting extension in addition to a baseline periodic reporting configuration; and receive from the first network node: an acknowledgement of the periodic location information extension configuration, an alternative supported periodic location information extension configuration, or a baseline response where only the baseline periodic reporting configuration in the request is to be supported, and thereby aligning a reporting configuration with the first network node.

It is furthermore provided herein a computer program product comprising instructions, which, when executed on at least one processor, cause the at least one processor to carry out the methods herein, as performed by the first, or the second network node, respectively. It is additionally provided herein a computer-readable storage medium, having stored thereon a computer program product comprising instructions which, when executed on at least one processor, cause the at least one processor to carry out the methods herein, as performed by the first, or the second network node, respectively.

Embodiments herein concern periodic location information reporting extensions where a first and second network node already support a baseline periodic location information reporting configuration, also referred to as a configuration for a baseline periodic reporting of location information. An advantage of embodiments herein is to incorporate an extension to a baseline periodic reporting framework that introduces support for a periodic reporting more adapted to industrial needs while ensuring backward compatibility. Thus, the location information may be handled in an efficient manner in the wireless communications network.

### BRIEF DESCRIPTION OF THE DRAWINGS

Embodiments will now be described in more detail in relation to the enclosed drawings, in which:

FIG. 1 shows a schematic architecture of a network;

FIG. 2 shows a schematic architecture of a network;

FIG. 3 shows a schematic architecture of a network;

FIG. 4 shows a wireless communications network according to embodiments herein;

FIG. 5 shows a combined signalling scheme and flow chart according to embodiments herein;

FIG. 6 shows a combined signalling scheme and flow chart according to embodiments herein;

FIG. 7 is depicting a method performed by a second network node (second node) according to embodiments herein;

FIG. 8 is depicting a method performed by a first network node (first node) according to embodiments herein;

FIG. 9 shows a combined signalling scheme and flow chart according to embodiments herein;

FIG. 10 is depicting a method performed by a second network node (second node) according to embodiments herein;

FIG. 11 is depicting a method performed by a first network node (first node) according to embodiments herein;

FIG. 12a shows a combined signalling scheme and flow chart according to embodiments herein;

FIG. 12b is depicting a method performed by a first network node according to embodiments herein;

FIG. 12c is depicting a method performed by a second network node according to embodiments herein;

FIG. 12d is depicting a method performed by a first network node according to embodiments herein;

FIG. 12e is depicting a method performed by a second network node according to embodiments herein;

FIG. 12f is depicting a method performed by a UE according to embodiments herein;

FIG. 13 shows a block diagram depicting the first network node according to embodiments herein

FIG. 14 shows a block diagram depicting the second network node according to embodiments herein;

FIG. 15 schematically illustrates a telecommunication network connected via an intermediate network to a host computer;

FIG. 16 is a generalized block diagram of a host computer communicating via a base station with a user equipment over a partially wireless connection; and

FIGS. 17, 18, 19, and 20 are flowcharts illustrating methods implemented in a communication system including a host computer, a base station and a user equipment.

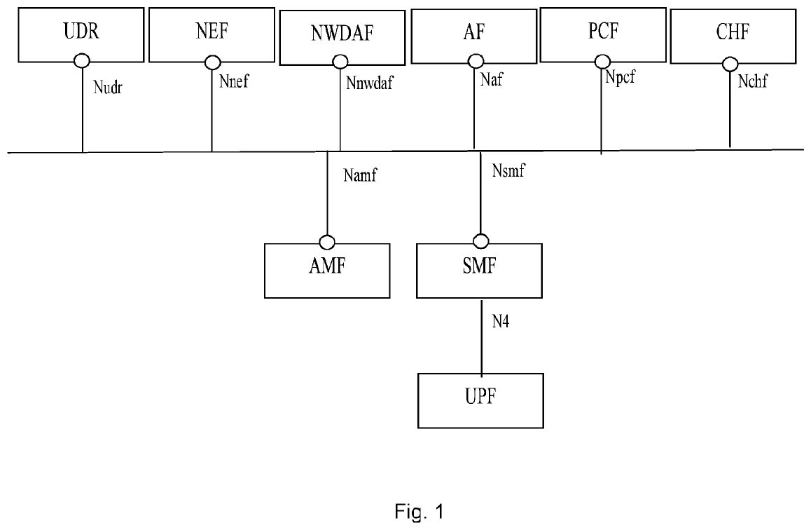

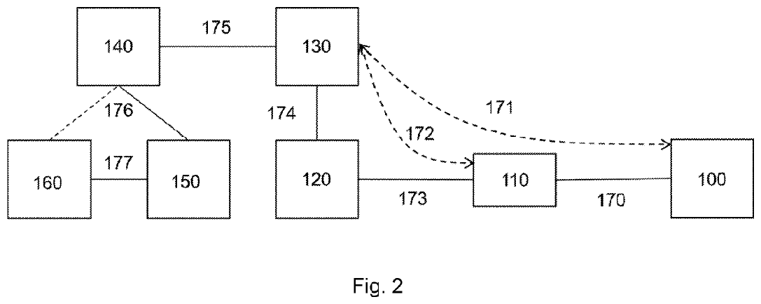

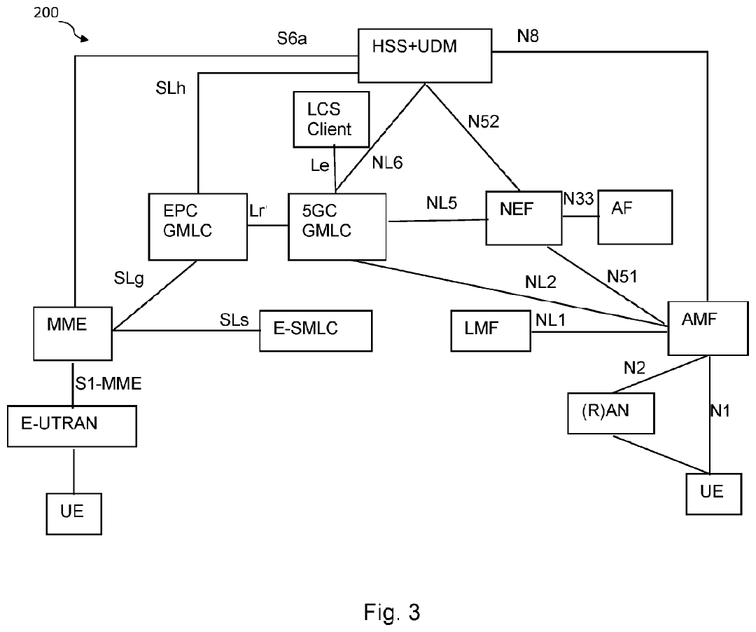

### DETAILED DESCRIPTION

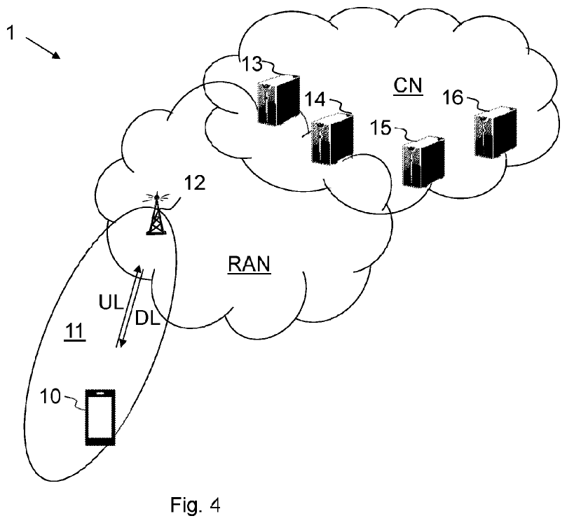

Embodiments herein relate to wireless communications networks in general. FIG. 4 is a schematic overview depicting a wireless communications network 1. The wireless communications network 1 comprises one or more RANs and one or more CNs. The wireless communications network 1 may use one or a number of different technologies. Embodiments herein relate to recent technology trends that are of particular interest in a New Radio (NR) context, however, embodiments are also applicable in existing wireless communications systems such as e.g. LTE or Wideband Code Division Multiple Access (WCDMA), and developments thereof.

In the wireless communications network 1, a user equipment (UE) 10, exemplified herein as a wireless device such as a mobile station, a non-access point (non-AP) station (STA), a STA and/or a wireless terminal, is comprised communicating via e.g. one or more Access Networks (AN), e.g. radio access network (RAN), to one or more core networks (CN). It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises a radio network node 12 providing radio coverage over a geographical area, a first service area 11 or first cell, of a first radio access technology (RAT), such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node depending e.g. on the first radio access technology and terminology used. The radio network node may be referred to as a serving radio network node wherein the service area may be referred to as a serving cell, and the serving network node communicates with the UE in form of DL transmissions to the UE and UL transmissions from the UE. It should be noted that a service area may be denoted as cell, beam, beam group or similar to define an area of radio coverage.

The wireless communications network further comprises a number of core network nodes/network function nodes such as a first network node 13, for example, a location node such as a Gateway mobile location center (GMLC), an LMF, or a NF node, a second network node 14 for example, a location node such as a GMLC, an LMF, the UE 10, or an application function (AF) node, a third network node 15, for example, a location node a location node such as a GMLC, an LMF, or an AF node, and a fourth network node 16 for example, a location node such as a GMLC, an LMF, or the UE 10 or the radio network node 12. Network nodes are herein exemplified in accordance with NR terminology, it should however be noted that embodiments may herein be implemented in system of other RATs such as LTE or similar.

According to embodiments herein the first network node 13 and the second network node 14 aligns a reporting configuration, wherein the reporting configuration defines an extension of a baseline periodic location information reporting configuration The alignment may be triggered upon request and/or upon capability exchange. The aligned reporting configuration may be referred to as periodic location information reporting extension configuration, extended location reporting configuration, extended periodic location reporting configuration or similar. Thus, the first and second network node use a same or similar reporting configuration, a coordinated reporting configuration, a reporting configuration with same reporting interval or reporting amount (number of reports).

Embodiments herein concern alignment of reporting configurations, where the first network node 13 and the second network node 14 already support a baseline periodic location information reporting configuration. The baseline periodic location information reporting configuration may comprise
a set of supported baseline reporting intervals, such as time ranges
a set of supported baseline reporting amounts, such as number of reports.

The baseline periodic location information reporting configuration may also be referred to as the baseline configuration, the baseline reporting configuration, or similar.

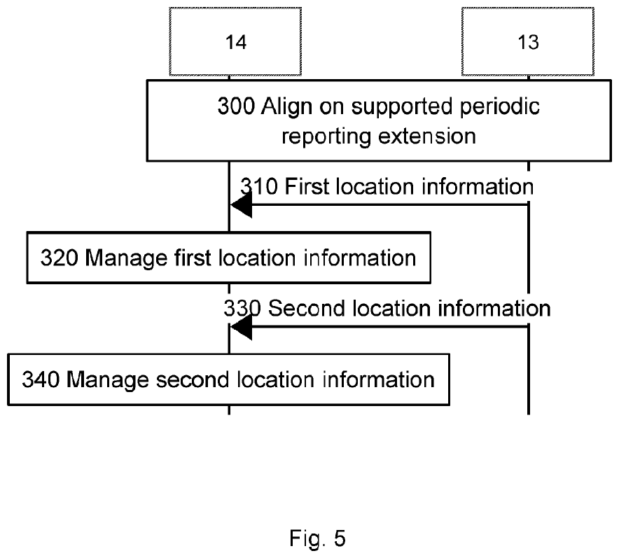

FIG. 5 illustrates an example of a signalling chart, the actions mentioned may be taken in any suitable order, where action 300 comprises an alignment between the first network node 13 and second network node 14 of a periodic location information reporting extension configuration, which extends the baseline periodic location information reporting configuration. Based on the aligned reporting configuration, the first network node 13 may provide to the second network node 14 a first location information, see action 310, and a second location information, see action 330, where a time difference between the first location information and second location information is in accordance to the aligned reporting configuration, and the amount of location information reports is aligned in accordance to the reporting configuration. The second network node 14 manages, see action 320, the first location information, and manages, see action 340, the second location information. For example, the second network node 14 may manage the second location information by forwarding the second location information to the third network node 15 with which a periodic location information reporting extension configuration may have been aligned. Another example, the second network node 14 may manage the second location information by using the obtained second location information in some procedure that is based on periodically reported location information.

A trigger for the second network node 14 to initiate the alignment between the first network node 13 and the second network node 14 of a periodic location information reporting extension configuration is that it is engaged in an alignment of a periodic location information reporting extension configuration with the third network node 15.

The first network node 13 may, when the alignment between the first network node 13 and the second network node 14 of a periodic location information reporting extension configuration has been initiated, initiate an alignment between the first network node 13 and the fourth network node 16 of a periodic location information reporting extension configuration.

Examples of nodes in 5G systems comprises (and are not limiting):
First network node 13 is a network exposure function and the second network node an application function, fourth network node is a GMLC
First network node 13 is a GMLC, second network node is an LMF or SLP, third network node is an application function, fourth network node is a UE or a radio base station
First network node 13 is an LMF or SLP, second network node is a UE, third network node is a GMLC

The alignment of reporting configuration comprising the periodic location information reporting extension configuration may be triggered upon request and/or upon capability exchange.

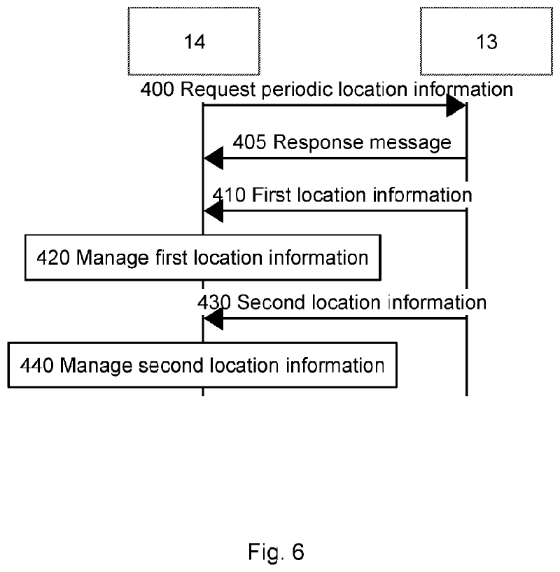

The alignment between the first network node 13 and the second network node 14 of the periodic location information reporting extension configuration may be based on a request and response procedure, an example is illustrated in FIG. 6. The alignment of reporting configuration may be initiated by the second network node 14 sending, action 400, a request for periodic location information reporting comprising an extension configuration in addition to a baseline configuration. The request may also comprise a specific baseline configuration that corresponds to a fallback configuration in case the first network node 13 does not support the extension. In response, the first network node 13 may send, action 405, a periodic location information response. The periodic location information response may comprise one or more of the following:
A. an acknowledgement of the periodic location information extension configuration;
B. an alternative supported periodic location information extension configuration; and/or
C. a baseline response where only the baseline configuration in the request is to be supported.

Based on the aligned periodic location information reporting extension configuration, the first network node 13 may provide to the second network node 14 the first location information, action 410, and the second location information, action 430, wherein the time difference between the first and second location information is in accordance to the aligned periodic location information reporting extension configuration, and the amount of location information reports is aligned in accordance to the aligned periodic location information reporting extension configuration, The second network node 14 may then manage, action 420, the first location information, and manage, action 440, the second location information.

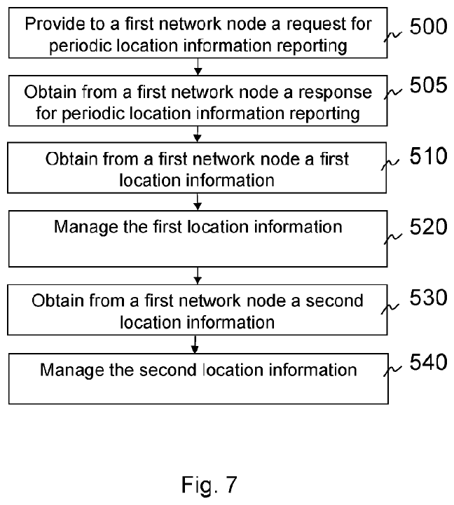

From the perspective of the second network node 14, an example is illustrated in FIG. 7, the second network node 14 sends, action 500, a request for a periodic location information reporting extension configuration comprising an extension configuration in addition to a baseline configuration. The baseline configuration is a specific configuration that corresponds to a fallback configuration in case the first network node 13 does not support the extension.

The second network node 14 obtains, action 505, a response such as a periodic location information response from the first network node. The response may comprise one or more of the following:
A. an acknowledgement of the periodic location information extension configuration;
B. an alternative supported periodic location information extension configuration; and/or
C. a baseline response where only the baseline configuration in the request is to be supported.

Thereby, the first network node 13 and the second network node 14 has an alignment about the periodic location information reporting extension configuration, and the second network node 14 concludes that periodic location information will be provided in accordance to either A, B and/or C. Based on the aligned configuration, the second network node 14 may obtain from the first network node 13 a first location information, action 510, and a second location information, action 530, where the time difference between the first location information and the second location information is in accordance to the aligned periodic location information reporting extension configuration, and the amount of location information reports is aligned in accordance to the periodic location information reporting extension configuration. The second network node 14 may manage, action 520, the first location information, and may manage, action 540, the second location information.

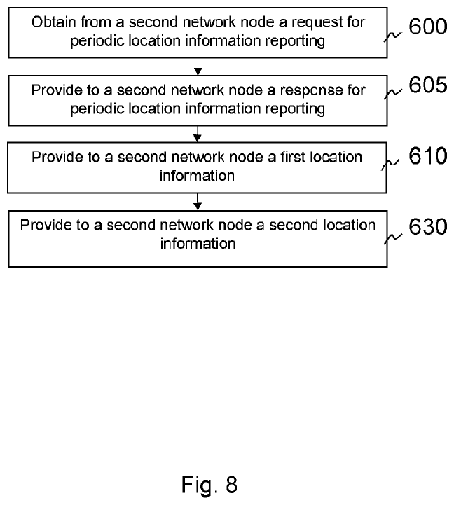

From the perspective of the first network node 13, an example is illustrated in FIG. 8, the first network node 13 may obtain, action 600, a request for periodic location information reporting comprising an extension configuration in addition to a baseline configuration. The baseline configuration may be a specific configuration that may correspond to a fallback configuration in case the first network node 13 does not support the extension.

The first network node 13 may send, action 605, a response to the second network node 14. The response may comprise one or more of the following:
As in A, comprise an acknowledgement of the periodic location information extension configuration—this implies that the first network node 13 complies with the suggested periodic location information configuration from the second network node 14 and will provide periodic location information accordingly;
As in B, comprise an alternative supported periodic location information extension configuration—this implies that the first network node 13 does not support the suggested periodic location information configuration from the second network node 14 and will instead provide periodic location information according to the alternative periodic location information.
As in C, comprise a baseline response where only the baseline configuration in the request is to be supported—this implies that the first network node 13 does not support the periodic location information extension configuration, for example its supported protocol version does not comprise the periodic location information extension configuration.

Thereby, the first network node 13 and second network node 14 have an alignment about the periodic location information configuration, i.e., aligned periodic location information reporting extension configuration, and the first network node 13 may check or determine that periodic location information may be provided in accordance to either A, B or C. Based on the aligned configuration, the first network node 13 may provide to the second network node 14 the first location information, action 610, and the second location information, action 630, wherein the time difference between the first location information and the second location information is in accordance to the aligned periodic location information reporting extension configuration, and the amount of location information reports may be aligned in accordance to the periodic location information reporting extension configuration.

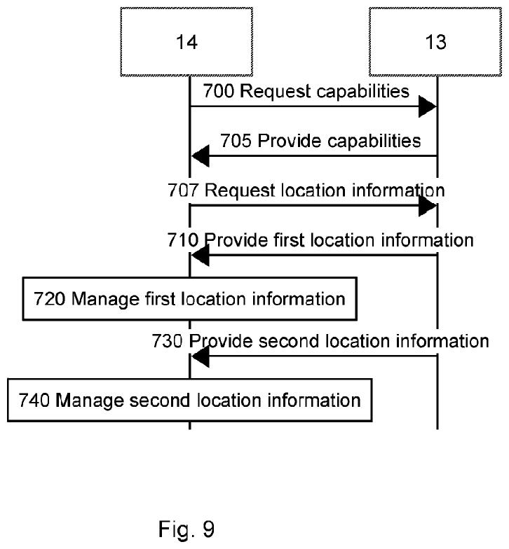

Alternatively, or additionally, the alignment between the first network node 13 and the second network node 14 of the periodic location information reporting extension configuration is based on a capability request and response procedure, an example is illustrated in FIG. 9. The alignment is initiated by the second network node 14 sending, action 700, a request for capabilities. The request for capability may comprise information about what specific capabilities that are requested.

The request may also comprise a specific baseline configuration that corresponds to a fallback configuration in case the first network node does not support the extension.

In response, the first network node 13 may send, action 705, a capability response comprising one or more of
baseline periodic location information reporting support; and/or
periodic location information reporting extension support

The periodic location information reporting extension support may comprise additional information about the type of supported periodic location information reporting extension. Examples include a minimum reporting interval, a set of supported reporting interval, a maximum reporting amount, and/or indicator of support for infinite reporting amount.

Based on the capabilities, the second network node may send, action 707, a location information request comprising a periodic location information reporting extension configuration, and optionally a baseline periodic location information reporting configuration. The baseline configuration, i.e. the periodic location information reporting configuration, may comprise a default periodic reporting interval, a reporting amount that may be set to infinite, etc. The extension configuration, that is, the periodic location information reporting extension configuration, may comprise a finer periodic reporting interval, a refined reporting amount, etc. The combination of a baseline reporting interval and an extension reporting interval may be used to ensure backward compatibility so that a first network node 13 not supporting the extension configuration will use the baseline configuration. Alternatively, or additionally, the combination of a baseline reporting interval and an extension reporting interval may be used due to a mandatory baseline reporting interval to be included, instructed to be ignored in the protocol specification. Alternatively, or additionally, the information reporting extension configuration, instead of a baseline periodic location information reporting configuration, where the extension configuration may comprise one or more of a reporting interval and a reporting amount. Thereby, the first network node 13 and the second network node 14 have aligned periodic location information reporting configuration with extension.

The first network node 13 may provide the first location information, action 710, and the second location information, action 730, where the time difference between the first and second location information is in accordance to the aligned periodic location information reporting extension configuration, and the amount of location information reports is aligned in accordance to the periodic location information reporting extension configuration, The second network node 14 may manage, action 720, the first location information, and may manage, action 740, the second location information.

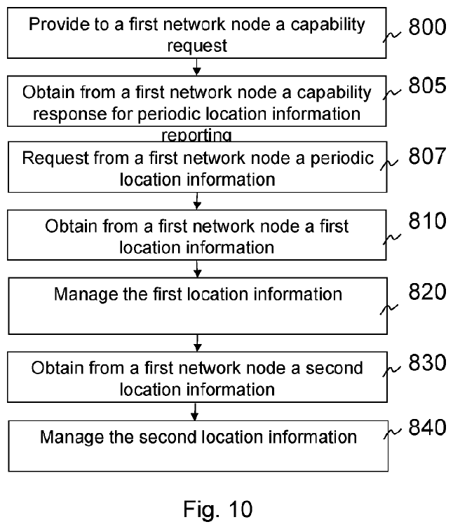

From the perspective of the second network node 14, an example is illustrated in FIG. 10, the second network node 14 may send, action 800, a capability request. The request may comprise instructions about what capabilities that are requested. The first network node 13 may respond with capabilities comprising support for a periodic location information reporting extension configuration in addition to a baseline configuration.

The second network node 14 may thus obtain, action 805, a periodic location information capability response from the first network node 13. The periodic location information capability response may comprise one or more of the following:
baseline periodic location information reporting support; and/or
periodic location information reporting extension support

The periodic location information reporting extension support may comprise additional information about the type of supported periodic location information reporting extension. Examples include a minimum reporting interval, a set of supported reporting interval, a maximum reporting amount, and/or indicator of support for infinite reporting amount.

Based on the capabilities, the second network node 14 may send, action 807, a location information request comprising a periodic location information reporting extension configuration, and optionally a baseline periodic location information reporting configuration. The baseline configuration may comprise a default periodic reporting interval, a reporting amount that may be set to infinite, etc. The extension configuration may comprise a finer periodic reporting interval, a refined reporting amount, etc. The combination of a baseline reporting interval and an extension reporting interval may be used to ensure backward compatibility so that a first network node not supporting the extension configuration will use the baseline configuration. The combination of a baseline reporting interval and an extension reporting interval may be used due to a mandatory baseline reporting interval to be included, instructed to be ignored in the protocol specification. The information reporting extension configuration, instead of a baseline periodic location information reporting configuration, where the extension configuration may comprise one or more of a reporting interval and a reporting amount. Thereby, the first network node 13 and second network node 14 have aligned the periodic report configuration.

The second network node 14 may then obtain a first location information, action 810, and a second location information, action 830, where the time difference between the first and second location information is in accordance to the aligned periodic location information reporting extension configuration, and the amount of location information reports is aligned in accordance to the periodic location information reporting extension configuration, The second network node 14 may manage, action 820, the first location information, and may manage, action 840, the second location information.

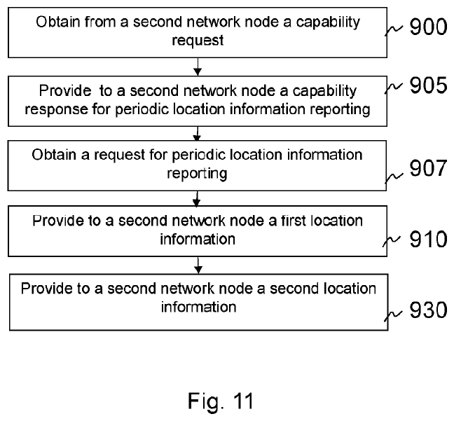

From the perspective of the first network node 13, an example is illustrated in FIG. 11, the first network node 13 may obtain, action 900, a capability request. The capability request may comprise instructions about what capabilities that are requested. The first network node 13 may respond, action 905, with capabilities comprising support for a periodic location information reporting extension configuration in addition to a baseline configuration.

The response may comprise one or more of the following:
baseline periodic location information reporting support; and/or
periodic location information reporting extension support

The periodic location information reporting extension support may comprise additional information about the type of supported periodic location information reporting extension. Examples include a minimum reporting interval, a set of supported reporting interval, a maximum reporting amount, and/or indicator of support for infinite reporting amount.

The first network node 13 may obtain, action 907, a location information request comprising a periodic location information reporting extension configuration, and, optionally, a baseline periodic location information reporting configuration. The baseline configuration may comprise a default periodic reporting interval, a reporting amount that may be set to infinite, etc. The extension reporting configuration may comprise a finer periodic reporting interval, a refined reporting amount, etc. The combination of a baseline reporting interval and an extension reporting interval may be used to ensure backward compatibility so that a first network node not supporting the extension configuration will use the baseline configuration. The combination of a baseline reporting interval and an extension reporting interval may be used due to a mandatory baseline reporting interval to be included, that may be instructed to be ignored in the protocol specification. The first network node 13 may send a location information request comprising a periodic location information reporting extension configuration, instead of a baseline periodic location information reporting configuration, where the extension configuration may comprise one or more of a reporting interval and a reporting amount. Thereby, the first network node 13 and second network node 15 have aligned the periodic report configuration.

The first network node 13 may provide the first location information, action 910, and the second location information, action 930, wherein the time difference between the first location information and the second location information is in accordance to the aligned periodic location information reporting configuration, and the amount of location information reports may be aligned in accordance to the periodic location information reporting extension configuration,

In any of the described procedures in FIGS. 9-11, the first network node 13 may request assistance data from the second network node 14 to support location information determination. The second network node 14 may provide assistance data to the first network node 13 to support location information determination, when not requested (unsolicited).

### Periodic Location Information Reporting Extension Configuration.

The extensions may be slightly differently configured in case of a request response procedure or a capability exchange procedure.

### Alignment Via Request and Response.

In case of a request and response procedure, the request from the second network node 14 may comprise a suggested periodic reporting extension in addition to a baseline periodic reporting configuration. The first network node 13 may be instructed to one or more of the following:
A: acknowledge the periodic location information extension configuration
B: provide an alternative supported periodic location information extension configuration
C: use a baseline response where only the baseline configuration in the request is to be supported.

The response message from the first network node 13 may indicate which of the alternatives A, B or C that will be used to ensure that the first and second network nodes are aligned.

The baseline configuration in the request may comprises:
a baseline reporting interval, for example a baseline reporting interval in integer seconds
a baseline reporting amount in integer numbers, for example where an infinite number is not encodable

A signaling example from NImf, see 3GPP TS 29.572 17.4.0, where the baseline configuration comprises a reporting interval and a reporting amount and the extension, underlined, a millisecond reporting interval and a boolean indicating an infinite reporting amount. If the extension is present, then the corresponding baseline configuration is ignored by a supporting first network node 13, but provided as a specific configuration for backward compatibility for example as
the minimum reporting interval of 1
the maximum reporting amount
   6.1.6.2.24 Type: PeriodicEventInfo (underlined parts added)

TABLE 6.1.6.2.24-1
Definition of type PeriodicEventInfo

| Attribute name | Data type | P | Cardinality | Description |
|---|---|---|---|---|
| reportingAmount | ReportingAmount | M | 1 | Number of event reports |
| reportingInterval | ReportingInterval | M | 1 | Interval of event reports |
| reportingInfiniteInd | boolean | O | 0 . . . 1 | When present, this IE shall be set to |
| | | | | the value true, indicating that as many |
| | | | | reports as possible to be generated |
| | | | | during allowed duration (8639999 |
| | | | | seconds). |
| | | | | When this IE is present in a request, |
| | | | | the reportingAmount should be set to |
| | | | | the largest possible value (see NOTE) |
| | | | | for backward compatibility |
| | | | | consideration. An LMF supporting this |
| | | | | IE shall ignore the reportingAmount IE |
| | | | | and an LMF not supporting this IE will |
| | | | | use reportingAmount IE to generate |
| | | | | indicated number of reports as legacy. |
| | | | | When this IE is present in a response, |
| | | | | it indicates that this IE is supported |
| | | | | and accepted by the LMF. |
| reportingIntervalMs | ReportingIntervalMs | 0 | 0 . . . 1 | When present, this IE shall indicate the |
| | | | | Interval of event reports in |
| | | | | milliseconds. |
| | | | | When this IE is present in a request, |
| | | | | the reportingInterval is set ot 1 for |
| | | | | backward compatible consideration. |
| | | | | An LMF supporting this IE shall ignore |
| | | | | the reportingInterval IE; an LMF not |
| | | | | supporting this IE will use |
| | | | | reportingInterval IE to generate report |
| | | | | with minimal interval as legacy, i.e. 1 |
| | | | | second. |
| | | | | When this IE is present in a response, |
| | | | | it indicates that this IE is supported by |
| | | | | the LMF and it shall indicate the value |
| | | | | accepted by the LMF. |

NOTE:
reportingAmount × reportingInterval shall not exceed 8639999 (99 days, 23 hours, 59 minutes and 59 seconds) for compatibility with OMA MLP and RLP.

Where the reportIntervaIMs may be defined as

| | | |
|---|---|---|
| ReportingIntervalMs | integer | Event reporting periodic interval in milliseconds. |
| | | Minimum: 1. Maximum: 999. |

A first network node 13 acknowledging the periodic reporting extension may provide a acceptedPeriodicEventInfo acknowledgement for example of the same type periodicEventInfo as the baseline and extension configuration of the request that either confirms the extension and baseline configuration in the request or provides a supported extension and baseline configuration. If no acknowledging configuration is included in the response, the second network node 14 may assume that the baseline configuration is aligned.

The corresponding signaling is considered also for NgmIc, see 3GPP TS 29.515 17.4.0, and Namf, see 3GPP TS 29.518 17.4.0, as well as for similar interfaces between similar nodes.

### Alignment Via Capability Exchange

For capability request and response, one signaling example is for LPP, see 3GPP TS 37.355 17.4.0, where the capability may be per positioning method. Examples of positioning methods can be
1. Assisted Global navigation satellite systems (A-GNSS)
2. LTE observed time difference of arrival
3. LTE enhanced cell id
4. Terrestrial beacon systems
5. Sensor positioning
6. WLAN positioning
7. Bluetooth positioning
8. NR uplink positioning
9. NR enhanced cell ID
10. NR downlink time difference of arrival
11. NR downlink angle of departure
12. NR multi roundtrip time

The periodic reporting base and extension respectively can also be supported in different positioning modes, such as standalone, no network assistance, UE-based, device estimates position, and UE-assisted, device provides measurements, network estimates position.

One capability signaling example is from LPP and GNSS. In this example, the capability regarding the millisecond periodic reporting interval is the same for all positioning modes, but an alternative could be to indicate the support per positioning mode. The support indicator could be only indicating the support for the millisecond reporting interval, or could be more detailed—for example to indicate a minimum reporting interval in milliseconds or a set of supported reporting intervals in millisecond. The example below indicates the minimum reporting interval as a set of alternatives—1 ms, 10 ms and 100 ms. Changes are marked as underlined.

### 6.5.2.9 GNSS Capability Information

### A-GNSS-ProvideCapabilities

The IE A-GNSS-Provide-Capabilities is used by the target device to indicate its capability to support A-GNSS and to provide its A-GNSS location capabilities (e.g., GNSSs and assistance data supported) to the location server.

```
-- ASN1START
A-CNSS-ProvideCapabilities ::= SEQUENCE {
  gnss-SupportList GNSS SupportList OPTIONAL,
  assistanceDatasupportList AssistanceDatasupportList OPTIONAL;
  locationCoordinateTypes LocationCoordinateTypes OPTIONAL,
  velocityTypes VelocityTypes OPTIONAL;
....
  [[ periodicalReportingNotSupported-r14
                          PositioningModes OPTIONAL,
    idlestateForMeasurements 14
                          ENUMERATED { required } OPTIONAL
  ]],
  [[ periodicAssistanceData-r15
                          BIT STRING { solicited (0),
unsolicited (1) } (SIZE (1 ...8)} OPTIONAL
  ]]
  [[ scheduledLocationRequestSupported-r17
                          ScheduledLocationTimeSupportPerMode-r17 OPTIONAL
  ]]
  [[periodicReportingIntervalMsSupport-r17 PeriodicReportingIntervalMsSupport r17 OPTIONAL
  ]]
}
GNSS-SupportList ::= SEQUENCE (SIZE(1...16)) OF GNSS-SupportElement
GNSS SupportElement ::= SEQUENCE {
  gnss-ID GNSS-ID,
  Sbas-IDS SBAS -IDS OPTIONAL, -- Cond GNSS-ID-SBAS
  agnss-Modes PositioningModes,
  gnss Signals GNSS-SignalIDS,
  fta Meas Support SEQUENCE {
                                    cellTime AccessTypes,
                                    mode PositioningModes,
                                    ...
                              } OPTIONAL, --Cond fta
  adr-Support BOOLEAN,
  velocityMeasurement Support BOOLEAN,
  . . .,
  [[
    adrEnhancements Support-r15 ENUMERATED { true } OPTIONAL,
    ha-gnss -Modes-r15 PositioningModes OPTIONAL
  ]],
  [[
    ha-gnss MetricsSupport-r17 ENUMERATED { true } OPTIONAL
  ]]
}
AssistanceDataSupport List : := SEQUENCE {
  gnss CommonAssistanceDatasupport GNSS CommonAssistanceDataSupport,
  gnss GenericAssistanceDataSupport GNSS GenericAssistanceDataSupport.
  ...
}
-- ASN1STOP
```

| Conditional presence | Explanation |
|---|---|
| GNSS-ID-SBAS | The field is mandatory present if the GNSS-ID = sbas; otherwise it is not present. |
| fta | The field is mandatory present if the target device supports the reporting of fine time |
| | assistance measurements; otherwise it is not present. |

A-GNSS-ProvideCapabilities field descriptions

gnss-SupportList
This field specifies the list of GNSS supported by the target device and the target device capabilities associated with
each of the supported GNSS. This field shall be present if the gnss-SupportListReq in the A-GNSS -
RequestCapabilities IE is set to TRUE and if the target device supports the A-GNSS positioning method. If the IE A-
GNSS-Provide-Capabilities is provided unsolicited, this field shall be included if the target device supports the assisted
GNSS positioning method.
gnss-ID
This field specifies the GNSS supported by the target device for which the capabilities in GNSS-SupportElement are
provided.
sbas-IDs
This field specifies the SBAS(s) supported by the target device. This is represented by a bit string, with a one-value at
the bit position means the particular SBAS is supported; a zero-value means not supported.
agnss-Modes
This field specifies the GNSS mode(s) supported by the target device for the GNSS indicated by gnss-ID. This is
represented by a bit string, with a one-value at the bit position means the particular GNSS mode is supported; a
zero-value means not supported.
gnss-Signals
This field specifies the GNSS signal(s) supported by the target device for the GNSS indicated by gnss-ID. This is
represented by a bit string, with a one-value at the bit position means the particular GNSS signal type is supported; a
zero-value means not supported.
fta-MeasSupport
This field specifies that the target device is capable of performing fine time assistance measurements (i.e.,
GNSS-cellular time association reporting). The cellTime field specifies for which cellular network(s) this capability is
supported. This is represented by a bit string, with a one-value at the bit position means FTA measurements for the
specific cellular network time is supported; a zero-value means not supported. The mode field specifies for which
GNSS mode(s) FTA measurements are supported by the target device. This is represented by a bit string, with a
one-value at the bit position means FTA measurements for the GNSS mode is supported; a zero-value means not
supported.
adr-Support
This field specifies whether the target device supports ADR measurement reporting. TRUE means supported.
velocityMeasurementSupport
This field specifies whether the target device supports measurement reporting related to velocity. TRUE means
supported.
assistanceDataSupportList
This list defines the assistance data and assistance data choices supported by the target device. This field shall be
present if the assistanceDataSupportListReq in the A-GNSS-RequestCapabilities IE is set to TRUE and if the target
device supports GNSS assistance data. If the IE A-GNSS-Provide-Capabilities is provided unsolicited, this field shall
be included if the target device supports any GNSS assistance data.
A-GNSS-ProvideCapabilities field descriptions
locationCoordinateTypes
This parameter identifies the geographical location coordinate types that a target device supports for GNSS. TRUE
indicates that a location coordinate type is supported and FALSE that it is not. This field shall be present if the
locationVelocityTypesReq in the A-GNSS-RequestCapabilities IE is set to TRUE and if the target device supports UE-
based or standalone GNSS positioning method. If the IE A-GNSS-Provide-Capabilities is provided unsolicited, this
field shall be included if the target device supports UE-based or standalone GNSS positioning method.
velocityTypes
This parameter identifies the velocity types that a target device supports for GNSS. TRUE indicates that a velocity
type is supported and FALSE that it is not. FALSE for all velocity types indicates that velocity reporting is not
supported. This field shall be present if the locationVelocityTypesReq in the A-GNSS-RequestCapabilities IE is set to
TRUE and if the target device supports UE-based or standalone GNSS positioning method. If the IE A-GNSS-Provide-
Capabilities is provided unsolicited, this field shall be included if the target device supports UE-based or standalone
GNSS positioning method.
periodicalReportingNotSupported
This field, if present, specifies the positioning modes for which the target device does not support periodicalReporting.
This is represented by a bit string, with a one-value at the bit position means periodicalReporting for the positioning
mode is not supported; a zero-value means supported. If this field is absent, the location server may assume that the
target device supports periodicalReporting in CommonlEsRequestLocationInformation for each supported positioning
mode.
idleStateForMeasurements
This field, if present, indicates that the target device requires idle state to perform GNSS measurements.
periodicAssistanceData
This field identifies the periodic assistance data delivery procedures supported by the target device. This is
represented by a bit string, with a one value at the bit position means the periodic assistance data delivery procedure
is supported; a zero value means not supported. Bit 0 (solicited) represents the procedure according to clause 5.2.1a;
bit (1) (unsolicited) represents the procedure according to clause 5.2.2a.
adrEnhancementsSupport
This field, if present, indicates that the target device supports the fields adrMSB, adrSign, adrRMSerror, and
delta-codePhase in IE GNSS-MeasurementList.
This field may only be present if adr-Support is set to TRUE, and shall be absent if adr-Support is set to FALSE.
ha-gnss-Modes
This field specifies the High-Accuracy GNSS mode(s) supported by the target device for the GNSS indicated by
gnss-ID. This is represented by a bit string, with a one-value at the bit position means the particular GNSS mode is
supported; a zero-value means not supported.
ha-gnss-MetricsSupport
This field specifies that high accuracy GNSS positioning metrics are supported by the target device.
scheduledLocationRequestSupported
This field, if present, specifies the positioning modes for which the target device supports scheduled location requests
- i.e., supports the IE ScheduledLocationTime in IE CommonIEsRequestLocationInformation - and the time base(s)
supported for the scheduled location time for each positioning mode. If this field is absent, the target device does not
support scheduled location requests.
periodicReportingIntervalMsSupport
This field, if present, indicates that the target device supports millisecond periodic reporting intervals for location
information - i.e., supports the subfield reportingintervalMs of the IE PeriodicalReportingCriteriaExt in IE
CommonIEsRequestLocationInformation - and the minimum millisecond report interval supported for the periodic
reporting.

The request for periodic location information is common to all positioning methods, while there can be positioning method specific information provided in the request.

One example request comprises an optional millisecond periodic reporting interval extension that will be considered instead of the baseline reporting interval. An alternative could be to provide an alternative periodic reporting extension that is included instead of the baseline configuration.

### CommonIEsRequestLocationInformation

The CommonIEsRequestLocationInformation carries common IEs for a Request Location Information LPP message Type.

```
-- ASN1START
CommonIEsRequestLocationInformation : := SEQUENCE {
  locationInformationType LocationInformationType,
  triggeredReporting TriggeredReportingcriteria OPTIONAL, -- Cond ECID
  periodicalReporting PeriodicalReportingCriteria OPTIONAL, -- Need ON
  additionalInformation AdditionalInformation OPTIONAL, -- Need ON
  qos QoS OPTIONAL, -- Need ON
  environment Environment OPTIONAL, -- Need ON
  locationcoordinateTypes LocationCoordinateTypes OPTIONAL, -- Need ON
  velocityTypes VelocityTypes OPTIONAL, -- Need ON
  ...,
  [[
    messageSizeLimitNB-r14 MessageSizeLimitNB-r14 OPTIONAL, -- Need ON
  ]],
  [[
    segmentationInfo-r14 SegmentationInfo-r14 OPTIONAL, -- Need ON
  ]],
  [[
    scheduledLocationtime-r17
                          ScheduledLocationTime-r17 OPTIONAL, -- Need ON
    targetIntegrityRisk-r17
                          TargetIntegrityRisk-r17 OPTIONAL, -- Need ON
  ]],
  [[
    periodicalReportingExt-r17 PeriodicalReportingcriteriaExt-r17 OPTIONAL, -- Need ON
  ]]
}
LocationInformationType ::= ENUMERATED {
  locationEstimateRequired,
  locationMeasurementsRequired,
  locationEstimatePreferred,
  locationMeasurementsPreferred,
  ...
}
PeriodicalReportingcriteria ::= SEQUENCE {
  reportingAmount ENUMERATED {
                                        ral, ra2, ra4, ra8, ra16, ra32,
                                        ra64, ra-Infinity
                                  } DEFAULT ra-Infinity,
  reportingInterval ENUMERATED {
                                      noPeriodicalReporting, r10-25,
                                      ri0-5, ril, ri2, ri4, ri8, ri16, ri32, ri64
                                  }
}
PeriodicalReportingcriteriaExt-r17 ::= SEQUENCE {
  reportingIntervalMs INTEGER(1..999),
  ...
}
TriggeredReportingcriteria ::= SEQUENCE {
  cellchange BOOLEAN,
  reportingDuration ReportingDuration,
  ...
}
ReportingDuration ::= INTEGER (0..255)
AdditionalInformation ::= ENUMERATED {
  onlyReturn InformationRequested,
  mayReturnAditionalInformation,
  ...
}
QoS ::= SEQUENCE {
  horizontalAccuracy HorizontalAccuracy OPTIONAL, -- Need ON
  verticalcoordinateRequest BOOLEAN;
  verticalAccuracy VerticalAccuracy OPTIONAL, -- Need ON
  responseTime ResponseTime OPTIONAL, -- Need ON
  velocityRequest BOOLEAN
  ...,
  [[ responseTimeNB-r14 ResponseTimeNB-r14 OPTIONAL, -- Need ON
  ]],
  [[ horizontalAccuracyExt-r15 HorizontalAccuracyExt-r15 OPTIONAL, -- Need ON
      verticalAccuracyExt-r15 VerticalAccuracyExt-r15 OPTIONAL -- Need ON
  ]]
}
HorizontalAccuracy ::= SEQUENCE {
  accuracy INTEGER (0.. 127);
  confidence INTEGER (0..100),
  ...
}
VerticalAccuracy ::= SEQUENCE {
  accuracy INTEGER (0..127),
  confidence INTEGER (0..100 )
  ...
}
HorizontalAccuracyExt-r15 ::= SEQUENCE {
  accuracyExt-r15 INTEGER (0..255)}
  confidence-r15 INTEGER (0.. 100);
  ...
}
VerticalAccuracyExt-r15 ::= SEQUENCE {
  accuracyExt-r15 INTEGER (0..255)}
  confidence-r15 INTEGER (0. .100) ;
  ...
}
ResponseTime ::= SEQUENCE {
  time INTEGER (1..128) ,
  ...,
  [[ responseTimeEarlyFix-r12 INTEGER (1..128) OPTIONAL -- Need ON
  ]],
  [[ unit-r15 ENUMERATED { ten seconds, ... , ten milli-seconds -1700 }
                                                              OPTIONAL -- Need ON
  ]]
}
ResponseTimeNB-r14 ::= SEQUENCE {
  timeNB=r14 INTEGER (1..512),
  responseTimeEarlyFixNB-r14 INTEGER (1..512) OPTIONAL, -- Need ON
  ...,
  [[ unitNB-r15 ENUMERATED { ten-seconds, --- } OPTIONAL -- Need ON
  ]]
}
Environment ::= ENUMERATED {
  badArea
  notBadArea,
  mixedArea,
  ...
}
MessageSizeLimitNB-r14 : : = SEQUENCE {
  measurementLimit-r14 INTEGER (1..512) OPTIONAL, -- Need ON
  ...
}
ScheduledLocationTime-r17 ::= SEQUENCE {
  utcTime-r17 UTCTime OPTIONAL; -- Need ON
  gnssTime-r17 SEQUENCE {
                        gnss-TOD-msec-r17 INTEGER (0..3599999),
                        gnss TimeIDr17 GNSS-ID
                  } OPTIONAL, -- Need ON
  networkTime-r17 CHOICE {
                      e-utraTime-r17 SEQUENCE {
                        lte PhyscellId-r17 INTEGER (0..503),
                        lte-ArfcnEUTRA-r17 ARFCN-ValueEUTRA;
                        lte-CellGlobalId-r17 CellGlobalIdEUTRA-AndUTRA
                                                                          OPTIONAL; -- Need ON
                        lte-SystemFrameNumber-r17 INTEGER (0..1023)
                        },
                        nr-Time-r17 SEQUENCE {
                          nr-PhyscellID-r17 NR-PhysCellID-r16,
                          nr-ARFCN-r17 ARFCN-ValueNR-r15,
                          nr-CellGlobalID-r17 NCGI-r15 OPTIONAL, -- Need ON
                          nr-SFN-r17 INTEGER (0..1023),
                          nr-Slot-r17 CHOICE {
                            scs15-r17 INTEGER 0..9),
                            scs30-r17 INTEGER (0..19),
                            scs60-r17 INTEGER (0..39),
                            scs120-r17 INTEGER (0..79)
                            } OPTIONAL -- Need ON
                        },
                        ...
                  } OPTIONAL, -- Need ON
  relativeTime-r17 INTEGER (1..1024) OPTIONAL -- Need ON
}
Target IntegrityRisk-r17 ::= INTEGER (10..90)
-- ASN1STOP
```

| Conditional presence | Explanation |
|---|---|
| ECID | The field is optionally present, need ON, if E-CID or NR E-CID is requested. Otherwise it |
| | is not present. |

CommonlEsRequestLocationInformation field descriptions

locationInformationType
This IE indicates whether the server requires a location estimate or measurements. For ‘locationEstimateRequired’,
the target device shall return a location estimate if possible, or indicate a location error if not possible. For
‘locationMeasurementsRequired’, the target device shall return measurements if possible, or indicate a location error if
not possible. For ‘locationEstimatePreferred’, the target device shall return a location estimate if possible, but may also
or instead return measurements for any requested position methods for which a location estimate is not possible. For
‘locationMeasurementsPreferred’, the target device shall return location measurements if possible, but may also or
instead return a location estimate for any requested position methods for which return of location measurements is not
possible.
triggeredReporting
This IE indicates that triggered reporting is requested and comprises the following subfields:
cellChange: If this field is set to TRUE, the target device provides requested location information each time the
primary cell has changed.
reportingDuration: Maximum duration of triggered reporting in seconds. A value of zero is interpreted to mean
an unlimited (i.e. “infinite”) duration. The target device should continue triggered reporting for the
reportingDuration or until an LPP Abort or LPP Error message is received.
The triggeredReporting field should not be included by the location server and shall be ignored by the target device if
the periodicalReporting IE or response Time IE or response TimeNB IE is included in
CommonIEsRequestLocationInformation.
periodicalReporting
This IE indicates that periodic reporting is requested and comprises the following subfields:
reportingAmount indicates the number of periodic location information reports requested. Enumerated values
correspond to 1, 2, 4, 8, 16, 32, 64, or infinite/indefinite number of reports. If the reportingAmount is
‘infinite/indefinite’, the target device shou-Id continue periodic reporting until an LPP Abort message is received.
The value ‘ra1’ shall not be used by a sender.
reportingInterval indicates the interval between location information reports and the response time
requirement for the first location information report. Enumerated values ri0-25, ri0-5, ri1, ri2, ri4, ri8, ri16, ri32,
ri64 correspond to reporting intervals of 1, 2, 4, 8, 10, 16, 20, 32, and 64 seconds, respectively. Measurement
reports containing no measurements or no location estimate are required when a reportinginterval expires
before a target device is able to obtain new measurements or obtain a new location estimate. The value
‘noPeriodicalReporting shall not be used by a sender.
periodicalReportingExt
This IE indicates that extended periodic reporting is requested and comprises the following subfields:
reportingIntervalMs indicates the interval between location information reports and the response time
requirement for the first location information report in milliseconds. If present, the field periodicalReporting shall also
be present with the subfield reportingInterval set to ri0-25 corresponding to 1 second, but will be igored by UEs
supporting reportingIntervalMs
additionalInformation
This IE indicates whether a target device is allowed to return additional information to that requested. If this IE
indicates ‘onlyReturnInformationRequested’ then the target device shall not return any additional information to that
requested by the server. If this IE indicates ‘mayReturnAdditionalInformation’ then the target device may return
additional information to that requested by the server. If a location estimate is returned, any additional information is
restricted to that associated with a location estimate (e.g. might include velocity if velocity was not requested but
cannot include measurements). If measurements are returned, any additional information is restricted to additional
measurements (e.g. might include E-CID measurements if A-GNSS measurements were requested but not E-CID
measurements).
qos
CommonlEsRequestLocationInformation field descriptions
This IE indicates the quality of service and comprises a number of sub-fields. In the case of measurements, some of
the sub-fields apply to the location estimate that could be obtained by the server from the measurements provided by
the target device assuming that the measurements are the only sources of error. Fields are as follows:
horizontalAccuracy indicates the maximum horizontal error in the location estimate at an indicated confidence
level. The ‘accuracy’ corresponds to the encoded uncertainty as defined in TS 23.032 [15] and ‘confidence’
corresponds to confidence as defined in TS 23.032 [15].
verticalCoordinateRequest indicates whether a vertical coordinate is required (TRUE) or not (FALSE)
verticalAccuracy indicates the maximum vertical error in the location estimate at an indicated confidence level
and is only applicable when a vertical coordinate is requested. The ‘accuracy’ corresponds to the encoded
uncertainty altitude as defined in TS 23.032 [15] and ‘confidence’ corresponds to confidence as defined in TS
23.032 [15].
responseTime
time indicates the maximum response time as measured between receipt of the
RequestLocationInformation and transmission of a ProvideLocationInformation. If the unit field is absent,
this is given as an integer number of seconds between 1 and 128. If the unit field is present with
enumerated value ‘ten-seconds’, the maximum response time is given in units of 10-seconds, between 10
and 1280 seconds. If the unit field is present with enumerated value ‘ten-milli-seconds’, the maximum
response time is given in units of 10-milli-seconds, between 0.01 and 1.28 seconds. If the
periodicalReporting IE is included in CommonlEsRequestLocationInformation, this field should not be
included by the location server and shall be ignored by the target device (if included).
responseTimeEarlyFix indicates the maximum response time as measured between receipt of the
RequestLocationInformation and transmission of a ProvideLocationInformation containing early location
measurements or an early location estimate. If the unit field is absent, this is given as an integer number of
seconds between 1 and 128. If the unit field is present with enumerated value ‘ten-seconds’, the maximum
response time is given in units of 10-seconds, between 10 and 1280 seconds. If the unit field is present with
enumerated value ‘ten-milli-seconds’, the maximum response time is given in units of 10-milli-seconds,
between 0.01 and 1.28 seconds. When this IE is included, a target should send a
ProvideLocationInformation (or more than one ProvideLocationInformation if location information will not fit
into a single message) containing early location information according to the response TimeEarlyFix IE and
a subsequent ProvideLocationInformation (or more than one ProvideLocationInformation if location
information will not fit into a single message) containing final location information according to the time IE. A
target shall omit sending a ProvideLocationinformation if the early location information is not available at
the expiration of the time value in the response TimeEarlyFix IE. A server should set the
response TimeEarlyFix IE to a value less than that for the time IE. A target shall ignore the
response TimeEarlyFix IE if its value is not less than that for the time IE.
unit indicates the unit of the time and response TimeEarlyFix fields. Enumerated value ‘ten-seconds’
corresponds to a resolution of 10 seconds. Enumerated value ‘ten-milli-seconds’ corresponds to a
resolution of 0.01 seconds. If this field is absent, the unit/resolution is 1 second. Enumerated value ‘ten-
milli-seconds’ is only applicable for NR E-CID Positioning, NR DL-TDOA Positioning, NR DL-AoD
Positioning, and NR Multi-RTT Positioning. If the enumerated value ‘ten-milli-seconds’ is included for
methods others than NR E-CID Positioning, NR DL-TDOA Positioning, NR DL-AoD Positioning, and NR
Multi-RTT Positioning the target device shall ignore the unit field.
velocityRequest indicates whether velocity (or measurements related to velocity) is requested (TRUE) or not
(FALSE).
responseTimeNB
If the periodicalReporting IE or response Time IE is included in CommonIEsRequestLocationinformation, this
field should not be included by the location server and shall be ignored by the target device (if included).
timeNB indicates the maximum response time as measured between receipt of the
RequestLocationInformation and transmission of a ProvideLocationInformation. If the unitNB field is absent,
CommonIEsRequestLocationInformation field descriptions
this is given as an integer number of seconds between 1 and 512. If the unitNB field is present, the
maximum response time is given in units of 10-seconds, between 10 and 5120 seconds.
responseTimeEarlyFixNB indicates the maximum response time as measured between receipt of the
RequestLocationInformation and transmission of a ProvideLocationInformation containing early location
measurements or an early location estimate. If the unitNB field is absent, this is given as an integer number
of seconds between 1 and 512. If the unitNB field is present, the maximum response time is given in units
of 10-seconds, between 10 and 5120 seconds. When this IE is included, a target should send a
ProvideLocationInformation (or more than one ProvideLocationInformation if location information will not fit
into a single message) containing early location information according to the response TimeEarlyFixNB IE
and a subsequent ProvideLocationInformation (or more than one ProvideLocationInformation if location
information will not fit into a single message) containing final location information according to the timeNB
IE. A target shall omit sending a ProvideLocationInformation if the early location information is not available
at the expiration of the time value in the response TimeEarlyFixNB IE. A server should set the
response TimeEarlyFixNB IE to a value less than that for the timeNB IE. A target shall ignore the
response TimeEarlyFixNB IE if its value is not less than that for the timeNB IE.
unitNB indicates the unit of the timeNB and response TimeEarlyFixNB fields. Enumerated value ‘ten-
second’ corresponds to a resolution of 10 seconds. If this field is absent, the unit/resolution is 1 second.
horizontalAccuracyExt indicates the maximum horizontal error in the location estimate at an indicated
confidence level. The ‘accuracyExt’ corresponds to the encoded high accuracy uncertainty as defined in TS
23.032 [15] and ‘confidence’ corresponds to confidence as defined in TS 23.032 [15]. This field should not be
included by the location server and shall be ignored by the target device if the horizontalAccuracy field is
included in QoS.
verticalAccuracyExt indicates the maximum vertical error in the location estimate at an indicated confidence
level and is only applicable when a vertical coordinate is requested. The ‘accuracyExt corresponds to the
encoded high accuracy uncertainty as defined in TS 23.032 [15] and ‘confidence’ corresponds to confidence as
defined in TS 23.032 [15]. This field should not be included by the location server and shall be ignored by the
target device if the verticalAccuracy field is included in QoS.
All QoS requirements shall be obtained by the target device to the degree possible but it is permitted to return a
response that does not fulfill all QoS requirements if some were not attainable. The single exception is time and
timeNB which shall always be fulfilled - even if that means not fulfilling other QoS requirements.
A target device supporting NB-IOT access shall support the response TimeNB IE.
A target device supporting HA GNSS shall support the HorizontalAccuracyExt, VerticalAccuracyEx, and unit fields with
enumerated value ‘ten-seconds’.
A target device supporting NB-IOT access and HA GNSS shall support the unitNB field.
environment
This field provides the target device with information about expected multipath and non line of sight (NLOS) in the
current area. The following values are defined:
badArea: possibly heavy multipath and NLOS conditions (e.g. bad urban or urban).
notBadArea: no or light multipath and usually LOS conditions (e.g. suburban or rural).
mixedArea: environment that is mixed or not defined.
If this field is absent, a default value of ‘mixedArea’ applies.
locationCoordinateTypes
This field provides a list of the types of location estimate that the target device may return when a location estimate is
obtained by the target.
velocityTypes
This fields provides a list of the types of velocity estimate that the target device may return when a velocity estimate is
obtained by the target.
CommonIEsRequestLocationInformation field descriptions
messageSizeLimitNB
This field provides an octet limit on the amount of location information a target device can return.
measurementLimit indicates the maximum amount of location information the target device should return in
response to the RequestLocationInformation message received from the location server.
The limit applies to the overall size of the LPP message at LPP level (LPP Provide Location Information), and
is specified in steps of 100 octets. The message size limit is then given by the value provided in
measurementLimit times 100 octets.
segmentationinfo
This field indicates whether this RequestLocationInformation message is one of many segments, as specified in
clause 4.3.5
scheduledLocationTime
This field indicates that the target device is requested to obtain location measurements or location estimate valid at
the scheduledLocation Time T and comprises the following subfields:
utcTime provides T in UTC in the form of YYMMDDhhmmssZ.
gnssTime provides T in GNSS system time of the GNSS indicated by gnss-TimeID.
gnss-TOD-msec specifies the GNSS TOD in 1-milli-second resolution rounded down to the nearest
millisecond unit.
networkTime provides T in E-UTRA or NR network time.
lte-PhysCellId, lte-ArfcnEUTRA, lte-CellGlobalId identifies the reference cell (E-UTRA) that is used for
the network time.
lte-systemFrameNumber specifies the system frame number in E-UTRA.
nr-PhysCellID, nr-ARFCN , nr-CellGlobalID identifies the reference cell (NR) that is used for the network
time.
nr-SFN specifies the system frame number in NR.
nr-Slot specifies the slot number in NR for the indicated subcarrier spacing (SCS). The total NR network
time is given by nr-SFN + nr-Slot.
relativeTime provides T in seconds from current time, where current time is defined as the time the
CommonIEsRequestLocationInformation was received.
NOTE 1: A location estimate returned to an LCS Client, AF or UE for a scheduled location time can be treated by the
LCS Client, AF or UE as an estimate of the location of the UE at the scheduled location time (see TS
23.273 [42]).
NOTE 2: If this field is present, at least one of utc Time, gnss Time, network Time, or relative Time shall be present.
targetIntegrityRisk
This field indicates the TIR for which the PL is requested. The TIR is calculated by P=10^{-0.1n} [hour1] where n is the
value of targetIntegrityRisk and the range is 10⁻¹ to 10⁻⁹ per hour.

Embodiments herein impact, for example, LPP [1] between UE to RAN for both 4G/LTE and 5G/NR, while inter-node signalling is impacted for 5G core network for, for example, Nimf [2], NgmIc [3] and Namf [4]. Annex documents are provided.

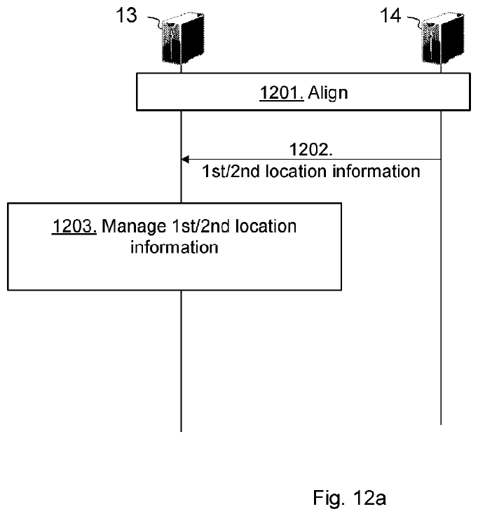

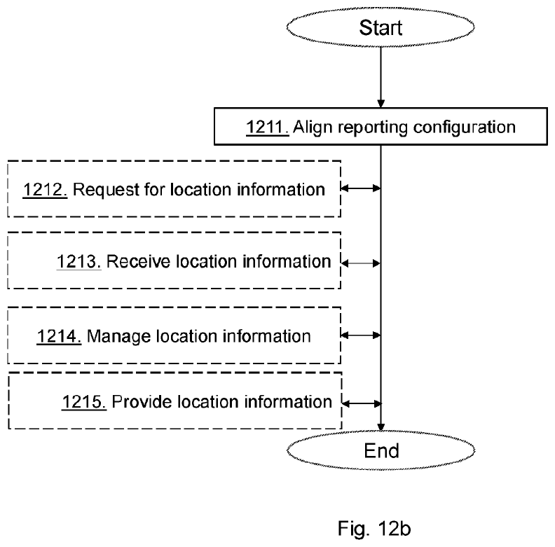

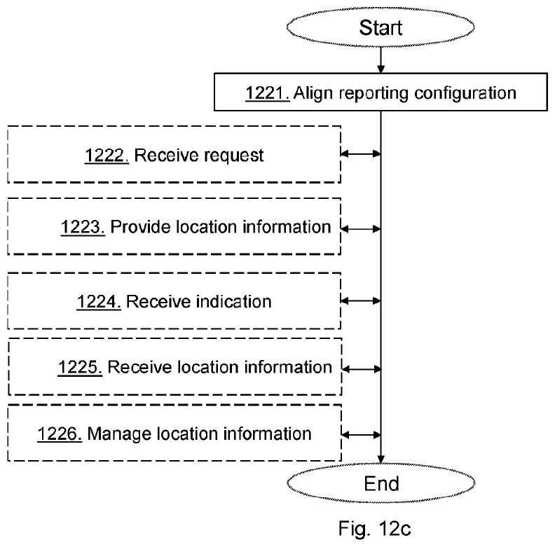

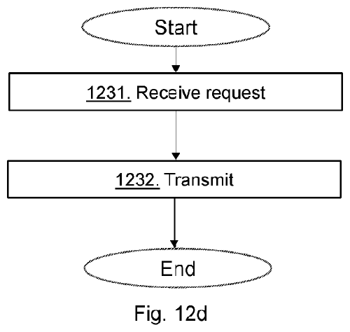

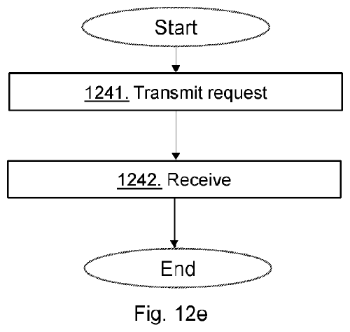

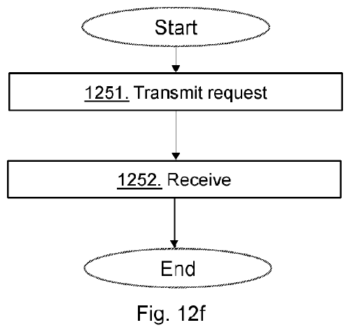

FIG. 12a is a combined flowchart and signalling scheme according to some embodiments herein.

Action 1201. The first network node 13 and the second network node 14 align the reporting configuration with one another. The aligned reporting configuration defines the extension of the baseline periodic location information reporting configuration. The alignment may be triggered upon request and/or upon capability exchange.

Action 1202. The second network node 14 may provide the first and second location information to the first network node 13 in accordance with the aligned reporting configuration.

Action 1203. The first network node 13 may then manage the first and second location information. It should be noted that it may be performed vice versa as stated in FIGS. 5-11.

Example embodiments of a method performed by the first network node 13 for handling location reporting in a wireless communications network will now be described with reference to a flowchart depicted in FIG. 12b. The actions do not have to be taken in the order stated below, but may be taken in any suitable order. Dashed boxes are optional features.

Action 1211. The first network node 13 aligns a reporting configuration with the second network node 14, wherein the reporting configuration defines an extension of a baseline periodic location information reporting configuration. This may be triggered upon request and/or upon capability exchange. The first network node 13 may align the reporting configuration with the second network node 14 by requesting a capability from the second network node 14. The first network node 13 may align the reporting configuration with the second network node 14 by receiving an indication of capability from the second network node 14.

Action 1212. The first network node 13 may request for location information from the second network node 14.

Action 1213. The first network node 13 may receive location information comprising first and/or second location information, from the second network node 14 in accordance with the aligned report configuration.

Action 1214. The first network node 13 may manage the location information.

The extension is defined by a finer periodic reporting interval, and/or a refined reporting amount than the baseline periodic location information reporting configuration.

Action 1215. The first network node 13 may provide location information comprising first and/or second information, to the second network node 14 in accordance with the aligned report configuration.

Example embodiments of a method performed by the second network node 14 for handling location reporting in a wireless communications network will now be described with reference to a flowchart depicted in FIG. 12c. The actions do not have to be taken in the order stated below, but may be taken in any suitable order. Dashed boxes are optional features.

Action 1221. The second network node 14 aligns the reporting configuration with the first network node 13, wherein the reporting configuration defines the extension of the baseline periodic location information reporting configuration. This may be triggered upon request and/or upon capability exchange. The second network node 14 may align the reporting configuration with the first network node 13 by receiving the request for a capability from the first network node 13. The second network node 14 may align the reporting configuration with the first network node 13 by providing the indication of capability to the first network node 13.

Action 1222. The second network node 14 may receive the request for location information from the first network node 13.

Action 1223. The second network node 14 may provide the location information comprising the first and/or second location information, to the first network node 13 in accordance with the aligned report configuration.

Action 1224. The second network node 14 may receive the indication of capability of the first network node 13, from the first network node 13.

Action 1225. The second network node 14 may receive the location information comprising the first and/or second location information, from the first network node 13 in accordance with the aligned report configuration.

Action 1226. The second network node 14 may manage the location information.

The extension may be defined by a finer periodic reporting interval, and/or a refined reporting amount than the baseline periodic location information reporting configuration

Example embodiments of a method performed by the first network node 13 for handling location reporting in a wireless communications network will now be described with reference to a flowchart depicted in FIG. 12d.

Action 1231. The first network node 13 receives a request from the second network node 14 comprising a suggested periodic reporting extension in addition to a baseline periodic reporting configuration.

Action 1232. The first network node 13 further transmits to the second network node 14: an acknowledgement of the periodic location information extension configuration; an alternative supported periodic location information extension configuration; or a baseline response where only the baseline periodic reporting configuration in the request is to be supported, and thereby aligning a reporting configuration with the second network node 14. The extension may be defined by: a finer periodic reporting interval, and/or a refined reporting amount than the baseline periodic location information reporting configuration. The extension may comprise a millisecond reporting interval and a boolean indicating an infinite reporting amount.

Example embodiments of a method performed by the second network node 14 for handling location reporting in a wireless communications network will now be described with reference to a flowchart depicted in FIG. 12e.

Action 1241. The second network node 14 transmits the request to the first network node 13 comprising a suggested periodic reporting extension in addition to a baseline periodic reporting configuration.

Action 1242. The second network node 14 further receives from the first network node 13: an acknowledgement of the periodic location information extension configuration, an alternative supported periodic location information extension configuration, or a baseline response where only the baseline periodic reporting configuration in the request is to be supported, and thereby aligning a reporting configuration with the first network node 13. The extension may be defined by: a finer periodic reporting interval, and/or a refined reporting amount than the baseline periodic location information reporting configuration. The extension may comprise a millisecond reporting interval and a boolean indicating an infinite reporting amount.

Example embodiments of a method performed by the UE 10 for handling location reporting in a wireless communications network will now be described with reference to a flowchart depicted in FIG. 12f.

Action 1251. The UE 10 transmits the request to the first network node 13 comprising a suggested periodic reporting extension in addition to a baseline periodic reporting configuration.

Action 1252. The UE 10 further receives from the first network node 13: an acknowledgement of the periodic location information extension configuration, an alternative supported periodic location information extension configuration, or a baseline response where only the baseline periodic reporting configuration in the request is to be supported, and thereby aligning a reporting configuration with the first network node 13. The extension may be defined by: a finer periodic reporting interval, and/or a refined reporting amount than the baseline periodic location information reporting configuration. The extension may comprise a millisecond reporting interval and a boolean indicating an infinite reporting amount.

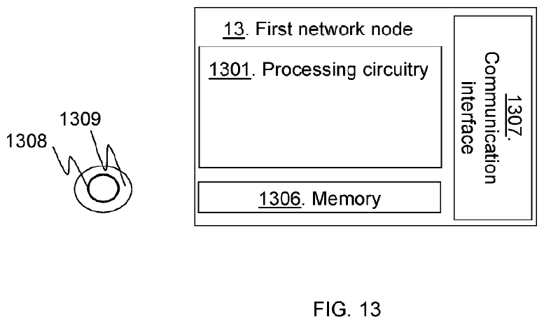

FIG. 13 is a block diagram depicting embodiments of the first network node 13, such as a location node, a network exposure function, or a NF node, for handling location reporting in a wireless communications network according to embodiments herein.

The first network node 13 may comprise processing circuitry 1301, e.g., one or more processors, configured to perform the methods herein.

The first network node 13, and/or the processing circuitry 1301 is configured to align the reporting configuration with the second network node 14, wherein the reporting configuration defines the extension of the baseline periodic location information reporting configuration. The alignment may be triggered upon request and/or upon capability exchange.

The first network node 13, and/or the processing circuitry 1301 may be configured to request the capability from the second network node 14.

The first network node 13, and/or the processing circuitry 1301 may be configured to request the location information from the second network node 14.

The first network node 13, and/or the processing circuitry 1301 may be configured to receive the indication of capability from the second network node 14.

The first network node 13, and/or the processing circuitry 1301 may be configured to receive location information comprising 1st and/or 2nd information, from the second network node 14 in accordance with the aligned report configuration.

The first network node 13, and/or the processing circuitry 1301 may be configured to manage the location information.

The first network node 13, and/or the processing circuitry 1301 may be configured to provide the indication of capability to the second network node 14.

The first network node 13, and/or the processing circuitry 1301 may be configured to provide the location information comprising 1st and/or 2nd information, to the second network node 14 in accordance with the aligned report configuration.

According to some embodiments, the first network node 13 is configured to receive the request from the second network node 14 comprising the suggested periodic reporting extension in addition to the baseline periodic reporting configuration. The first network node 13 is further configured to transmit to the second network node 14: an acknowledgement of the periodic location information extension configuration; an alternative supported periodic location information extension configuration; or a baseline response where only the baseline periodic reporting configuration in the request is to be supported, and thereby aligning a reporting configuration with the second network node 14. The extension may be defined by: a finer periodic reporting interval, and/or a refined reporting amount than the baseline periodic location information reporting configuration. The extension may comprise a millisecond reporting interval and a boolean indicating an infinite reporting amount.

The first network node 13 may comprise a memory 1306. The memory 1306 comprises one or more units to be used to store data on, such as data packets, location information, baseline configuration, extension configuration, mapping, indications, status indication, instance ID, UE IDs, mobility events, measurements, events and applications to perform the methods disclosed herein when being executed, and similar. Furthermore, the first network node 13 may comprise a communication interface 1307 comprising such as a transmitter, a receiver, a transceiver and/or one or more antennas.

The methods according to the embodiments described herein for the first network node 13 are respectively implemented by means of e.g., a computer program product 1308 or a computer program, comprising instructions, i.e., software code portions, which, when executed on at least one processor, cause the at least one processor to carry out the actions described herein, as performed by the first network node 13. The computer program product 1308 may be stored on a computer-readable storage medium 1309, e.g., a disc, a universal serial bus (USB) stick or similar. The computer-readable storage medium 1309, having stored thereon the computer program product, may comprise the instructions which, when executed on at least one processor, cause the at least one processor to carry out the actions described herein, as performed by the first network node 13. In some embodiments, the computer-readable storage medium may be a transitory or a non-transitory computer-readable storage medium. Thus, embodiments herein may disclose a first network node for handling testing in a wireless communications network, wherein the first network node comprises processing circuitry and a memory, said memory comprising instructions executable by said processing circuitry whereby said first network node is operative to perform any of the methods herein.

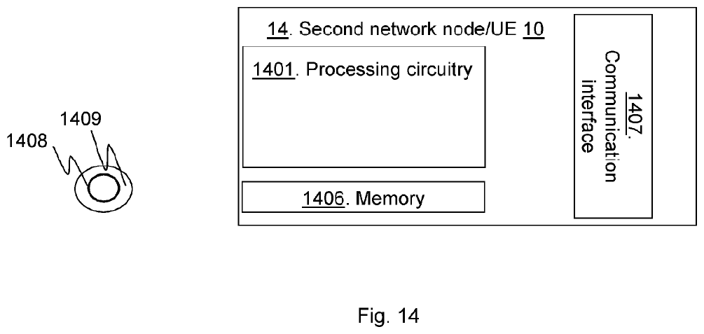

FIG. 14 is a block diagram depicting embodiments of the second network node 14, such as a location node, a UE, or an AF node, for handling location reporting in a wireless communications network 1 according to embodiments herein.

The second network node 14 may comprise processing circuitry 1401, e.g., one or more processors, configured to perform the methods herein.

The second network node 14, and/or the processing circuitry 1401 is configured to align the reporting configuration with the first network node 13, wherein the reporting configuration defines the extension of the baseline periodic location information reporting configuration. The alignment may be triggered upon request and/or upon capability exchange.

The second network node 14, and/or the processing circuitry 1401 may be configured to receive the request for capability from the first network node 13.

The second network node 14, and/or the processing circuitry 1401 may be configured to receive the request for location information from the second network node 14.

The second network node 14, and/or the processing circuitry 1401 may be configured to provide the indication of capability to the first network node 13.

The second network node 14, and/or the processing circuitry 1401 may be configured to provide the location information, comprising the 1st and/or 2nd information, to the first network node 13 in accordance with the aligned report configuration.

The second network node 14, and/or the processing circuitry 1401 may be configured to receive the location information, comprising the 1st and/or 2nd information, from the first network node 13 in accordance with the aligned report configuration.

The second network node 14, and/or the processing circuitry 1401 may be configured to manage the location information.

The second network node may be configured to: transmit the request to the first network node 13 comprising the suggested periodic reporting extension in addition to the baseline periodic reporting configuration; and receive from the first network node 13: an acknowledgement of the periodic location information extension configuration, an alternative supported periodic location information extension configuration, or a baseline response where only the baseline periodic reporting configuration in the request is to be supported, and thereby aligning the reporting configuration with the first network node 13.

In some embodiments the UE 10 for handling location reporting in a wireless communications network, wherein the UE is configured to transmit a request to a first network node 13 comprising a suggested periodic reporting extension in addition to a baseline periodic reporting configuration; and receive from the first network node 13: an acknowledgement of the periodic location information extension configuration, an alternative supported periodic location information extension configuration, or a baseline response where only the baseline periodic reporting configuration in the request is to be supported, and thereby aligning a reporting configuration with the first network node 13.

The second network node 14 may comprise a memory 1406. The memory 1406 comprises one or more units to be used to store data on, such as data packets, location information, capability indication, mapping, indications, status indication, instance ID, UE IDs, mobility events, measurements, events and applications to perform the methods disclosed herein when being executed, and similar. Furthermore, the second network node 14 may comprise a communication interface 1407 comprising such as a transmitter, a receiver, a transceiver and/or one or more antennas.

The methods according to the embodiments described herein for the second network node 14 are respectively implemented by means of e.g., a computer program product 1408 or a computer program, comprising instructions, i.e., software code portions, which, when executed on at least one processor, cause the at least one processor to carry out the actions described herein, as performed by the second network node 14. The computer program product 1408 may be stored on a computer-readable storage medium 1409, e.g., a disc, a universal serial bus (USB) stick or similar. The computer-readable storage medium 1409, having stored thereon the computer program product, may comprise the instructions which, when executed on at least one processor, cause the at least one processor to carry out the actions described herein, as performed by the second network node 14. In some embodiments, the computer-readable storage medium may be a transitory or a non-transitory computer-readable storage medium. Thus, embodiments herein may disclose a second network node for handling testing in a wireless communications network, wherein the second network node comprises processing circuitry and a memory, said memory comprising instructions executable by said processing circuitry whereby said second network node is operative to perform any of the methods herein.

It should be noted that “transmitting to” and “receiving from” also cover embodiments where a message is transmitted via some intermediate node, i.e., “to” can be interpreted as “towards” and “from” can be interpreted as “transmitted by” (not necessarily directly “to” or “from”).

In some embodiments a more general term “network node” is used and it can correspond to any type of radio-network node or any network node, which communicates with a wireless device and/or with another network node. Examples of network nodes are NodeB, MeNB, SeNB, a network node belonging to Master cell group (MCG) or Secondary cell group (SCG), base station (BS), multi-standard radio (MSR) radio node such as MSR BS, eNodeB, gNodeB, network controller, radio-network controller (RNC), base station controller (BSC), relay, donor node controlling relay, base transceiver station (BTS), access point (AP), transmission points, transmission nodes, Remote radio Unit (RRU), Remote Radio Head (RRH), nodes in distributed antenna system (DAS), etc.

In some embodiments the non-limiting term wireless device or user equipment (UE) is used and it refers to any type of wireless device communicating with a network node and/or with another wireless device in a cellular or mobile communication system. Examples of UE are target device, device to device (D2D) UE, proximity capable UE (aka ProSe UE), machine type UE or UE capable of machine to machine (M2M) communication, Tablet, mobile terminals, smart phone, laptop embedded equipped (LEE), laptop mounted equipment (LME), USB dongles etc.

Embodiments are applicable to any RAT or multi-RAT systems, where the wireless device receives and/or transmit signals (e.g. data) e.g. New Radio (NR), Wi-Fi, Long Term Evolution (LTE), LTE-Advanced, Wideband Code Division Multiple Access (WCDMA), Global System for Mobile communications/enhanced Data rate for GSM Evolution (GSM/EDGE), Worldwide Interoperability for Microwave Access (WiMax), or Ultra Mobile Broadband (UMB), just to mention a few possible implementations.

As will be readily understood by those familiar with communications design, that functions means or circuits may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware and/or program or application data. Other hardware, conventional and/or custom, may also be included. Designers of communications devices will appreciate the cost, performance, and maintenance trade-offs inherent in these design choices.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

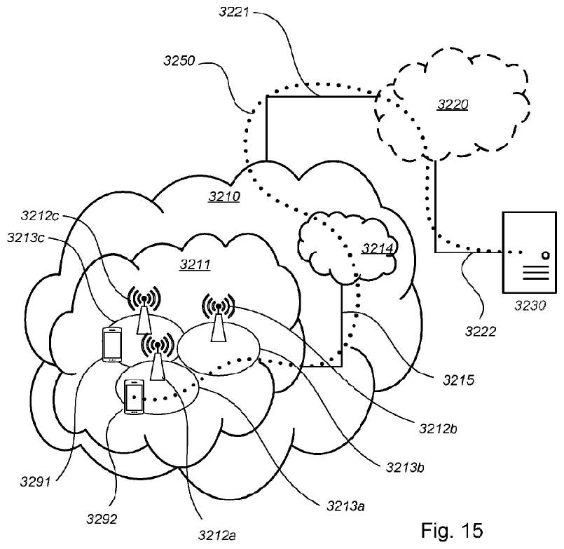

With reference to FIG. 15, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network node 12 herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 15 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

In some embodiments, the telecommunication network 3210 includes one or more Open-RAN (ORAN) network nodes. An ORAN network node is a node in the telecommunication network 3210 that supports an ORAN specification (e.g., a specification published by the O-RAN Alliance, or any similar organization) and may operate alone or together with other nodes to implement one or more functionalities of any node in the telecommunication network 3210, including one or more network nodes and/or core network nodes.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies. The network nodes facilitate direct or indirect connection of user equipment (UE), such as by connecting UEs (one or more of which may be generally referred to as UEs 3291, 3292) to the core network over one or more wireless connections.

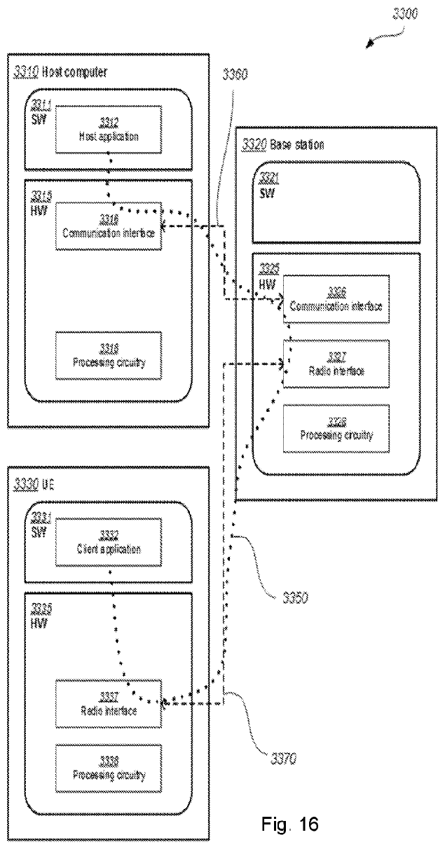

Example implementations, in accordance with an embodiment, of the UE, base station and host computer discussed in the preceding paragraphs will now be described with reference to FIG. 16. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 16) served by the base station 3320. The communication interface 3326 may be configured to facilitate a connection 3360 to the host computer 3310. The connection 3360 may be direct or it may pass through a core network (not shown in FIG. 16) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 16 may be identical to the host computer 3230, one of the base stations 3212a, 3212b, 3212c and one of the UEs 3291, 3292 of FIG. 15, respectively. This is to say, the inner workings of these entities may be as shown in FIG. 16 and independently, the surrounding network topology may be that of FIG. 15.

In FIG. 16, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may improve the performance since location information may be reported more flexible and may be handled more efficiently and thereby provide benefits such as reduced user waiting time, and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

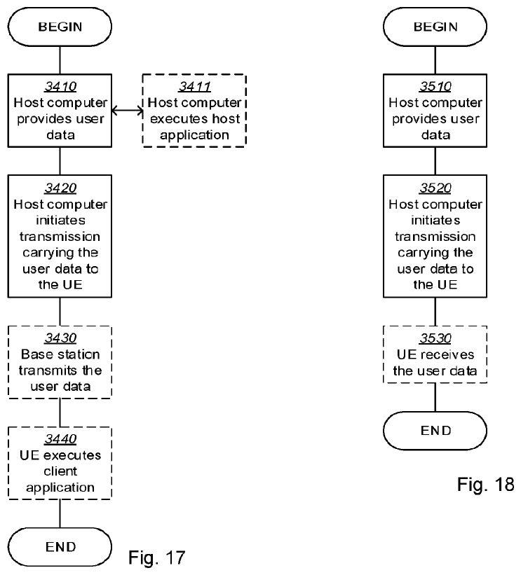

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

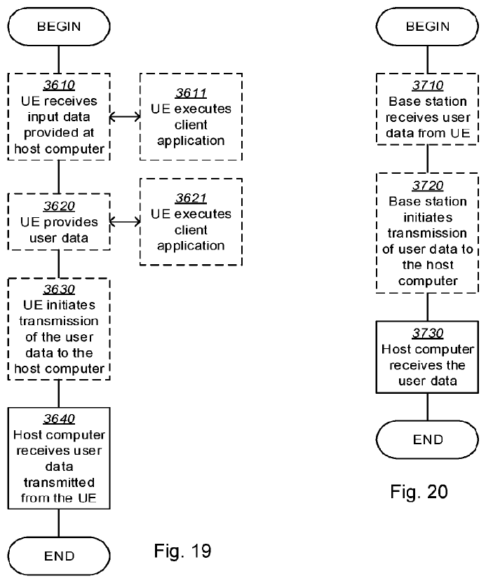

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 20 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a first network node for handling location reporting in a wireless communications network, the method comprising:
receiving a request from a second network node comprising a suggested periodic reporting extension in addition to a baseline periodic reporting configuration; and
transmitting to the second network node:
an acknowledgement of the periodic location information extension configuration;
an alternative supported periodic location information extension configuration; or
a baseline response where only the baseline periodic reporting configuration in the request is to be supported, and thereby aligning a reporting configuration with the second network node.

2. The method according to claim 1, wherein the extension is defined by one or both of a finer periodic reporting interval and a refined reporting amount than the baseline periodic location information reporting configuration.

3. The method according to claim 1, wherein the extension comprises a millisecond reporting interval and a boolean indicating an infinite reporting amount.

4. A method performed by a second network node for handling location reporting in a wireless communications network, the method comprising:
transmitting a request to a first network node comprising a suggested periodic reporting extension in addition to a baseline periodic reporting configuration; and
receiving from the first network node: an acknowledgement of the periodic location information extension configuration, an alternative supported periodic location information extension configuration, or a baseline response where only the baseline periodic reporting configuration in the request is to be supported, and thereby aligning a reporting configuration with the first network node.

5. The method according to claim 4, wherein the extension is defined by one or both of a finer periodic reporting interval and a refined reporting amount than the baseline periodic location information reporting configuration.

6. The method according to claim 4, wherein the extension comprises a millisecond reporting interval and a boolean indicating an infinite reporting amount.

7. A method performed by a user equipment, UE, for handling location reporting in a wireless communications network, the method comprising
transmitting a request to a first network node comprising a suggested periodic reporting extension in addition to a baseline periodic reporting configuration; and
receiving from the first network node: an acknowledgement of the periodic location information extension configuration, an alternative supported periodic location information extension configuration, or a baseline response where only the baseline periodic reporting configuration in the request is to be supported, and thereby aligning a reporting configuration with the first network node.

8. The method according to claim 7, wherein the extension is defined by one or both of a finer periodic reporting interval and a refined reporting amount than the baseline periodic location information reporting configuration.

9. The method according to claim 7, wherein the extension comprises a millisecond reporting interval and a boolean indicating an infinite reporting amount.

10. A method performed by a first network node for handling location reporting in a wireless communications network, the method comprising
aligning a reporting configuration with a second network node, wherein the reporting configuration defines an extension of a baseline periodic location information reporting configuration.

11. The method according to claim 10, wherein aligning the reporting configuration with the second network node is triggered one or both upon request and upon capability exchange.

12. The method according to claim 10, wherein aligning the reporting configuration with the second network node comprises requesting a capability from the second network node.

13. The method according to claim 10, wherein aligning the reporting configuration with the second network node comprises receiving an indication of capability from the second network node.

14. The method according to claim 10, comprising:
requesting for location information from the second network node.

15. The method according to claim 10, comprising:
receiving location information comprising first and/or second location information, from the second network node in accordance with the aligned report configuration.

16. The method according to claim 15, comprising:
managing the location information.

17. The method according to claim 10, wherein the extension is defined by one or both of a finer periodic reporting interval and a refined reporting amount than the baseline periodic location information reporting configuration.

18. The method according to claim 10, comprising:
providing location information comprising first and/or second information, to the second network node in accordance with the aligned report configuration.

19.-37. (canceled)

38. The method according to claim 11, wherein aligning the reporting configuration with the second network node comprises requesting a capability from the second network node.

39. The method according to claim 11, wherein aligning the reporting configuration with the second network node comprises receiving an indication of capability from the second network node.
